(19) United States
(12) Patent Application Publication
(10) Pub. No.: US 2008/0009985 A1
(43) Pub. Date: Jan. 10, 2008

(54) Semi-autonomous guidance system for a vehicle

(76) Inventor: Paul J. Plishner, Southhampton, NY (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/880,897

(22) Filed: Jul. 23, 2007

Related U.S. Application Data
(63) Continuation of application No. 11/227,993, filed on Sep. 14, 2005.

(51) Int. Cl. G05D 1/00; G05D 13/00

(52) U.S. Cl. 701/23

(57) ABSTRACT

A system (and corresponding method) by which a number of trailing vehicles follows (more or less in line, one behind the other) a lead vehicle, and so forms a convoy, with each of the trailing vehicles receiving a guidance signal from the vehicle ahead of it in order to determine its course (although in case of emergency, the trailing vehicles can each receive commands from the lead vehicle to alter the path indicated by the guidance signal from the vehicle ahead of it).

### CROSS REFERENCE To RELATED APPLICATIONS

This application makes reference to U.S. patent application Ser. No. 11/227,993 filed Sep. 14, 2005, from which priority is claimed under all applicable sections of Title 35 of the United States Code including, but not limited to, Sections 120 and/or 121.

### BACKGROUND OF THE INVENTION

1. Technical Field

The present invention pertains to the field of wholly or partially self-guided vehicles, including in particular ground vehicles. More particularly, the present invention pertains to a system by which a vehicle obtains guidance information from a nearby vehicle as a result of active or passive monitoring for such information.

2. Discussion of Related Art and Motivation for the Present Invention

The prior art for autonomous guided vehicles is replete with complex systems, taking into account all eventualities, in general having to do with both navigation and collision avoidance. The US Government agency DARPA (Defense Advanced Research Projects Agency) has issued what it calls a Grand Challenge, offering a prize for a vehicle that can best fulfill a set of requirements for autonomous operation. The Grand Challenge is intended to accelerate research and development in autonomous ground vehicles that will help save American lives on the battlefield. Highly sophisticated optical sensing units—e.g. a dual beam sweeping laser system that detects edges of obstacles and terrain gradients in real time—are used as components of such autonomous vehicles.

Although there are many situations where a truly autonomous vehicle is highly desirable, there are also many situations where a vehicle more modest in its autonomous capabilities is also useful and highly desirable.

For example, in case of a convoy, where there is a lead vehicle and a number of trailing vehicles following in line, it would be highly advantageous if the trailing vehicles could be guided directly or indirectly by the lead vehicle so they could be unmanned. The trailing vehicles would then be semi-autonomous, since they would be unmanned but guided by the lead vehicle, which would itself be either unmanned and truly autonomous, or remotely controlled, or operated by personnel. A large amount of equipment and supplies could then be delivered with (at least in some applications) only one vehicle—the lead vehicle—having an especially high cost. Thus, e.g. in case of a military convoy delivering supplies and equipment in hostile territory, only the lead vehicle would have to be provided as truly autonomous or else either remotely or directly controlled by an operator. In case of the lead vehicle being directly controlled, only the lead vehicle would have to be armored against small arms fire or other lethal threats. The other vehicles might be either unprotected or else simply hardened so as to likely withstand attack without becoming unable to continue with the convoy.

A convoy having a lead vehicle providing guidance (directly or indirectly) to trailing vehicles would also be advantageous in other than military operations. Many civilian trucking companies today have a truck pulling two or sometimes even three trailers, mechanically linked. The cost savings of having only a single driver pull what otherwise would have required two or three drivers is a great benefit to such companies. But having a lead vehicle provide guidance to trailing vehicles allows a further cost savings, because although the cost of each trailing vehicle is greater than a simple trailer (since the trailing vehicles would be self-propelled), the convoy could still be operated by a single driver but could be significantly longer than a two or three-trailer trucking rig.

Moreover, the idea of having a lead vehicle provide guidance (directly or indirectly) to trailing vehicles can be of use not only in case of ground vehicles, but also in case of air vehicles, and even in case of sea vehicles—either underwater vehicles or above-water vehicles. Not relying on a mechanical linking to the trailing vehicles and instead some sort of guidance to a propulsion/ steering system, in effect keeps the trailing vehicles in what might be called elastic tow, i.e. not mechanically and relatively rigidly connected but connected nonetheless, electronically, allowing for greater variation in separation than a mechanical linkage. Since the trailing vehicles are not rigidly connected, aircraft and ship or undersea vehicle convoys are possible where they would perhaps not be possible in case of a mechanical tow.

### DISCLOSURE OF INVENTION

Accordingly, in a first aspect of the invention, an apparatus is provided (of use in enabling a convoy of vehicles having a lead vehicles and one or more trailing vehicles following the lead vehicle more or less in line, one behind the other), comprising: a receiver (located in a trailing vehicle), for receiving a guidance signal from a leading vehicle (which would be the lead vehicle only if the trailing vehicle is the second vehicle in the convoy); means for determining the direction to the leading vehicle and the distance to the leading vehicle based on the received guidance signal; and means for providing control signals for moving along a path defined by successive determinations of the distance and direction to the leading vehicle. (The trailing vehicle would then provide such a guidance signal to a next-in-line vehicle.)

In case of emergency, the trailing vehicles can each also receive commands directly from the lead vehicle, commands that are here called convoy commands, including commands to follow a different path than that indicated by the guidance signals from the vehicle ahead of it. Also, the following vehicles can issue distress signals to signal different distress situations, and the lead vehicle can then issue appropriate convoy commands in response.

A corresponding method is also provided, i.e. a method by which a convoy of vehicles stays more or less in line, following a lead vehicle.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram of a convoy of vehicles, according to the invention.

FIG. 2 is a more detailed block diagram/flow diagram of the lead vehicle and the next vehicle in the convoy of FIG. 1.

FIG. 3 is a block diagram showing an embodiment of the lead vehicle of FIGS. 1 and 2.

### BEST MODE FOR CARRYING OUT THE INVENTION

The invention will first be described in case of a convoy progressing under routine conditions, with all vehicles in the convoy operating normally and able to continue as part of the convoy.

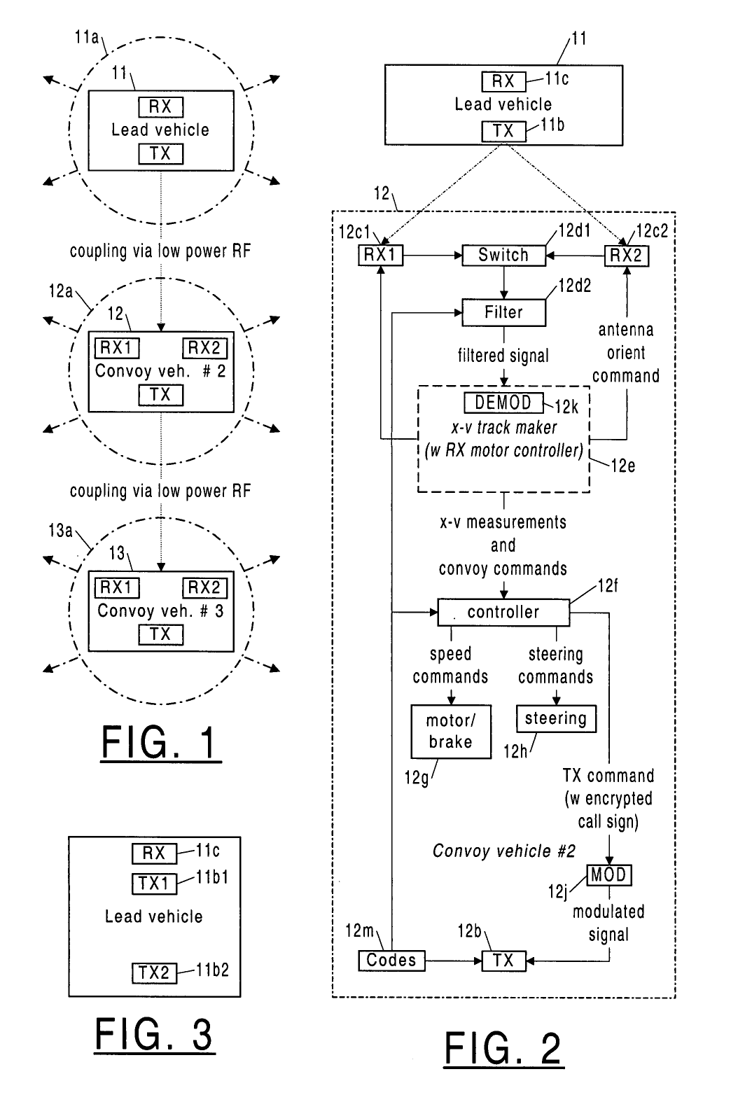

Referring to FIG. 1, a convoy is shown including a lead vehicle 11 that may be an autonomous guided vehicle (AGV), or a remotely controlled vehicle, or a vehicle under the direct operation of a driver. Second and third convoy vehicles 12 13 are not AGV's, but are typically unmanned (i.e. not typically under the control of an operator), and not remotely controlled. Each uses a signal from the vehicle ahead of it in the convoy for guidance.

Referring now to both FIGS. 1 and 2, according to the invention, the lead vehicle 11 includes a transmitter TX 11b for transmitting a low-power radio frequency (RF) signal 11a conveying a call sign for the lead vehicle, advantageously provided as an encrypted digital communication in a form allowing authentication (that the signal was transmitted by the vehicle having the indicated call sign). The low-power RF signal is of such a power that it has an effective range of only about 20 meters, in that a receiver using ordinarily-sensitive antennas and amplifiers cannot discern the low-power RF signal when the transmitter is more than about 20 meters away. The low-power RF signal can be of any frequency range in the RF spectrum, i.e. having a wavelength of more than about one tenth of a meter, and is modulated so as to convey the call sign of the lead vehicle. The second convoy vehicle 12 (i.e. the first vehicle in the convoy after the lead vehicle) includes a first receiver (RX) 12c1 and a spatially separated second receiver 12c2, each including an antenna (or antenna array) having an orientation under the control of a position-velocity (x-v) track maker module 12e. The signals received by the antennae of the receivers 12b 12c are received alternately, i.e. first one, then the other, using a switch element 12d1 and then filtered by a filter 12d2 in order to select out the signal from the lead vehicle, and are then provided to the x-v track maker module, which continually reorients the antennae so as to point them in the direction that maximizes the filtered signal strength, and thereby finds the direction to the lead vehicle from each of the two antennae. Using triangulation, the distance to the lead vehicle (from either antenna, or from a predetermined location in the second convoy vehicle) is determined given the direction to the lead vehicle from each antenna, and the distance between the two antennae. The x-v track maker 12e stores the distance and direction to the lead vehicle as a function of time, and determines from such measurements a velocity (speed and direction) for the lead vehicle as a function of time. The position (x) and velocity (v) are then provided to a controller module 12f, which sends corresponding steering commands to a steering mechanism 12h, and corresponding speed commands to a motor/ brake mechanism 12g.

The controller does not simply aim the second convoy vehicle at the lead vehicle, but instead follows the x-v track indicated by the series of x-v measurements it receives from the x-v track maker 12e. Thus, the second convoy vehicle will follow the lead vehicle around a corner by following in the “electronic x-v track” provided by the signals transmitted by the lead vehicle. In following the electronic x-v track, the second convoy vehicle will speed up where the lead vehicle speeded up, and will slow down where the lead vehicle slowed down.

The x-v track maker 12e advantageously includes a demodulator (DEMOD) 12k for demodulating the signal received by the two receivers 12c1 12c2, in order to confirm the call sign expected to be conveyed by the signal (and as explained below, in order to obtain from a received signal possible convoy commands issued by the lead vehicle). Any signal not including the expected call sign and not authenticated as coming from the lead vehicle (in the case of the second convoy vehicle) is ignored. For such authentication, known techniques of e.g. pubic key digital signature encoding could be used. A codes data store 12m would include the call signs of each vehicle in the convoy and also the parameters needed to authenticate the signal from each vehicle in the convoy (as well as to receive those signals, which would all be provided on different communications channels, i.e. e.g. on different frequencies).

Referring now especially to FIG. 2, the second convoy vehicle 12 also broadcasts a low-power RF signal 12a, which is used by the third convoy vehicle 13 to provide an x-v track for the third convoy vehicle to follow. Like the low-power RF signal from the lead vehicle, the low power RF signal 12a of the second convoy vehicle is modulated with a call sign, in this case that of the second convoy vehicle. A modulator 12j modulates a carrier (provided by an oscillator, not shown) for transmission by a transmitter 12b (advantageously located at the back of the vehicle).

The frequency (or frequencies) to be transmitted by the second convoy vehicle 12, the frequency (or frequencies) to be received, as well as parameters for encryption and de-encryption, are included in the codes data store 12m. The filter 12d2, x-v track maker 12e, controller 12f, and transmitter 12b obtain their operational parameters from all refer to the codes data store. The codes data store can even provide a frequency hopping algorithm or a code for use in code division multiple access transmission and reception.

All other convoy vehicles are similarly equipped. Thus, and now referring again to FIG. 1, the third convoy vehicle 13 broadcasts its own low-power RF signal 13a for guiding a next convoy vehicle (not shown), and uses the low-power RF signal 12a broadcast by the second convoy vehicle 12 as its own guide.

Advantageously, and now referring to FIG. 3, in order for a following vehicle to determine the orientation of the vehicle ahead of it, each vehicle (except perhaps for the last vehicle, of course) broadcasts two different signals, using two spatially separated transmitters, and each vehicle (except for the first) determines the direction and distance to each of the two transmitters in the vehicle ahead (by filtering first for the signal from one, and then from the other). The two signals may for example differ in frequency, and the filter 12d2 may alternately switch between the different frequencies of the two transmitters. (Another way to have the two signals differ would be to have them transmitted alternately, first one then the other, and so on.) Thus, the lead vehicle 11 advantageously includes not only a single transmitter 11b (as in FIGS. 1 and 2), but both a forward-placed first transmitter 11b1, and also a rear-placed second transmitter 11b2. The other convoy vehicles could be similarly equipped.

Now in case of a problem encountered by the convoy, the operator of the lead vehicle may decide to speed up the convoy, or slow down or even stop. It is advantageous, however, to do so while keeping an optimum separation between the convoy vehicles, which depends on the speed of the convoy. (If the convoy is stopped, e.g. the optimum separation would be less than five meters. If, though, the convoy is moving at e.g. 100 km/hr, the optimum separation would be much more, e.g. 30 meters.)

Thus, the lead vehicle has, according to the invention, a facility for transmitting not only a first quite low power signal (used for guidance only) but also a higher power (but still relatively low power) second signal so as to easily reach all convoy vehicles, and thus having a range of perhaps 100-200 meters, a range that could be tailored to the convoy. In the event of a need (according to the operator of the lead vehicle if the lead vehicle is manned) to substantially and immediately change the speed of the convoy, the lead vehicle could broadcast a speed change (digitally encrypted, so as to allow authentication) via the higher power transmission. Either the same or a different communication channel (e.g. the same or a different frequency) as that used for the low-power transmission (the guidance signal transmission) could be used for the higher power transmission.

Thus, and referring again to FIG. 2, the demodulator 12k included in the x-v track maker 12e (but which could also be provided as a separate module) demodulates signals provided to it not only to determine call signs (and to authenticate the sender of signals bearing the call signs), but also to demodulate any higher-power signal that may be issued by the lead vehicle and conveying a convoy command. (If the higher power signal is provided on a different communication channel than the low-power signal used simply for guidance, then it too is provided in a form in which it can be authenticated, i.e. e.g. it too is e.g. digitally signed.)

Each vehicle in the convoy at least periodically (if not continually) monitors the frequency used by the lead vehicle in case of such an emergency broadcast issuing convoy commands. (For example, the filter 12d can periodically switch to the frequency used by the lead vehicle.) If the lead vehicle signals a stop command to the convoy, all vehicle would come to an immediate stop. If the lead vehicle signals as a convoy command a speed increase speed of e.g. 5 km/hr, then all vehicles would so increase their speed immediately, which would result in different vehicles still moving at different speeds if they were doing so before receiving the increase speed convoy command.

In an especially advantageous embodiment of the invention, each vehicle (and in particular the x-v track maker 12e of each vehicle) remembers the path it has followed, and if a convoy command to back up is given, each vehicle would simply back up along the path it previously followed.

In case of a following vehicle losing the signal from the (leading) vehicle ahead of it (e.g. because the vehicle ahead of it has been destroyed), the following vehicle could stop and use the emergency broadcast signal to issue a distress call on (advantageously, but not necessarily) a separate communication channel from that used by the lead vehicle for issuing convoy commands. The distress call would indicate the following vehicle sending the distress call. Referring again to FIG. 2, the lead vehicle, which would continually monitor for such calls, could then issue one or another convoy command (after authenticating the distress call). The convoy commands could include a “sound off” command, asking for each vehicle, in turn, to indicate its call sign and status. If the vehicle leading the vehicle that issued the distress call does not sound off, then it would be presumed to be disabled and blocking the way of the rest of the convoy, in which case the lead vehicle could issue one or more convoy commands to the following vehicle (the one that issued the distress call) that in effect would take the rest of the convoy around the disabled vehicle. (For example, the convoy command to vehicle number four could be to turn left, proceed 5 meters, turn right, proceed 10 meters, and then turn left again and proceed 5 meters, and finally turn left and proceed until contact is made with vehicle number two via the guidance signal being transmitted by vehicle number two. The other convoy vehicles would of course follow the same path.)

Now the invention has been described for an embodiment in which a leading vehicle emits a guidance signal received by a trailing vehicle using two spatially separated receivers, and the trailing vehicle then uses triangulation to determine the relative position of the leading vehicle (i.e. its distance and direction from the trailing vehicle). Thus, the trailing vehicle can be said to be passive, in that the signal it receives is not provided as a result of any action by itself (and in fact is the result of action by the leading vehicle). Now another embodiment in the class of passive monitoring embodiments, and one not requiring two spatially separated receivers, is an embodiment in which each vehicle emits its low-power guidance signal at a predetermined power setting, and a calibration is performed to determine received power as a function of the distance to the vehicle. In such an embodiment, triangulation would be unnecessary for determining distance to the leading vehicle, but the receiver in the trailing vehicle would have to mechanically or at least electronically (using beam forming techniques) “look” for the transmitter to determine the direction to the transmitter (by determining at which relative direction the received power is the highest).

Besides a trailing vehicle using passive monitoring for signals emitted by the vehicle ahead of it, the invention also encompasses using active probing by the trailing vehicle, and so receiving a signal that is reflected from the leading vehicle. For example, the trailing vehicle could use a low-power radar to find the leading vehicle, or could use optical signals reflected off the leading vehicle. With such active probing, although the trailing vehicle receives the guidance signal, it also originates the signal (as opposed to having the leading vehicle do so, as in the above description).

Note that the invention is of use in case of a convoy of vehicles in any terrain, and even in case of air vehicles and sea vehicles, even including underwater vehicles.

Now the invention has been described in terms of modules of an apparatus. But the invention also comprehends a method including steps corresponding to the above-described functionality of the various above-mentioned modules. Thus, for each module described above, there can be one or more steps of a method according to the invention, although it is also possible for there to be several different steps corresponding to a single module.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. An apparatus, for use in a vehicle, comprising:
means for receiving a first guidance signal and a second guidance signal from a leading vehicle, wherein the second guidance signal differs from the first guidance signal;
means for determining the direction to the leading vehicle and the distance to the leading vehicle based on at least one of the received guidance signals;
means for providing control signals for moving along a path defined by successive determinations of the distance and direction to the leading vehicle; and
means for determining the relative orientation of the leading vehicle based on the first and second guidance signals.

2. An apparatus as in claim 1, further comprising:
means for receiving a convoy command signal; and
means for providing control signals for moving along a path differing from the path defined by successive determinations of the distance and direction to the lead vehicle, in response to the convoy command signals.

3. An apparatus as in claim 2, wherein the convoy command signals are provided as a set of one or more radio frequencies differing from a set of one or more radio frequency signals used to provide the guidance signal.

4. An apparatus as in claim 2, wherein the convoy commands include a back up command, and the apparatus further comprises means for storing at least a portion of the path already followed and leading to the present location, and for retracing the path in a backward orientation.

5. An apparatus as in claim 1, wherein the means for receiving the guidance signals comprises a first and second receiver antenna in spaced apart relation, separated by a known distance, and wherein the apparatus further comprises means for determining the distance and direction to the leading vehicle using triangulation based on direction information provided by each of the receiver antennas, and also based on the known distance between the first and second receiver antennas.

6. An apparatus as in claim 1, further comprising a first transmitter antenna, for providing a further guidance signal for use in providing guidance to another vehicle.

7. An apparatus as in claim 6, further comprising a second transmitter antenna, spatially separated from the first transmitter antenna, for providing a second further guidance signal, differing from the first signal.

8. A method, for use by equipment in a vehicle, comprising:
a step of receiving a first guidance signal and a second guidance signal from a leading vehicle, wherein the second guidance signal differs from the first guidance signal;
a step of determining the direction to the leading vehicle and the distance to the leading vehicle based on at least one of the received guidance signals;
a step of providing control signals for moving along a path defined by successive determinations of the distance and direction to the leading vehicle; and
a step of determining the relative orientation of the leading vehicle based on the first and second guidance signals.

9. A method as in claim 8, further comprising:
a step of receiving a convoy command signal; and
a step of providing control signals for moving along a path differing from the path defined by successive determinations of the distance and direction to the lead vehicle, in response to the convoy command signals.

10. A method as in claim 9, wherein the convoy command signals are provided as a set of one or more radio frequencies differing from a set of one or more radio frequency signals used to provide the guidance signal.

11. A method as in claim 9, wherein the convoy commands include a back up command, and the method further comprises a step of storing at least a portion of the path already followed and leading to the present location, and a step of retracing the path in a backward orientation.

12. A method as in claim 8, wherein in receiving the first and second guidance signals, a first and second receiver antenna are used, spatially separated by a known distance, each receiving the first and second guidance signals, and in determining the distance and direction to the leading vehicle, triangulation is performed based on direction information provided by each of the two receiver antennas, and also based on the known distance between the first and second receiver antennas.

13. A method as in claim 8, further comprising a step of using a first transmitter antenna for providing a further guidance signal for use in providing guidance to another vehicle.

14. A method as in claim 13, further comprising a step of using a second transmitter antenna, spatially separated from the first transmitter, for providing a second further guidance signal, differing from the first signal.

15. An apparatus, for use in a vehicle, comprising:
a first transmitter, for transmitting a guidance signal for use by a following vehicle;
a second transmitter in spaced apart relation to the first transmitter, for providing a second guidance signal for use by the following vehicle.

16. An apparatus as in claim 15, further comprising:
means for providing a convoy command signal for use by the following vehicle, wherein the convoy command signal indicates control signals for moving along a path differing from the path followed by the vehicle.

17. A method, for use by equipment in a vehicle, comprising:
transmitting a guidance signal for use by a following vehicle, using a first transmitter;
providing a second guidance signal for use by the following vehicle, using a second transmitter in spaced apart relation to the first transmitter.

18. A method as in claim 17, further comprising:
providing a convoy command signal for use by the following vehicle, wherein the convoy command signal indicates control signals for moving along a path differing from the path followed by the vehicle.
